(19) United States
(12) Patent Application Publication
(10) Pub. No.: US 2024/0007150 A1
(43) Pub. Date: Jan. 4, 2024

(54) Telecommunication method for iterative reception and corresponding devices

(71) Applicant: ORANGE, Issy-les-Moulineaux (FR)

(72) Inventor: Raphaël Visoz, CHATILLON CEDEX (FR)

(21) Appl. No.: 18/255,723

(22) PCT Filed: Dec. 2, 2021
(86) PCT No.: PCT/FR2021/052179

§ 371 Date: Jun. 2, 2023

(30) Foreign Application Priority Data
Dec. 3, 2020 (FR) FR2012579

(51) Int. Cl. H04B 7/0417; H04B 7/06; H04B 7/0452

(52) U.S. Cl. CPC H04B 7/0417; H04B 7/063; H04B 7/0628; H04B 7/0452

(57) ABSTRACT

A telecommunication method with feedback, from a terminal to an access point, of a minimum processing time required for the terminal to perform N iterations of iterative decoding with interference cancellation on at least one data packet transmitted by the access point and carried by a single physical channel.

### CROSS-REFERENCE TO RELATED APPLICATIONS

This Application is a Section 371 National Stage Application of International Application No. PCT/FR2021/052179, filed Dec. 2, 2021, which is incorporated by reference in its entirety and published as WO 2022/117963 A1 on Jun. 9, 2022, not in English.

### FIELD OF THE INVENTION

The present invention relates to the field of telecommunications. Within this field, the invention relates more particularly to digital communications with iterative reception of a radio signal (6G, 5G, WiFi, etc.) and feedback of an indicator relating to a minimum processing time required at reception for a given number of iterations.

It relates in particular to access points and to portable telecommunication devices that are compatible with standards (5G, 6G, etc.).

### PRIOR ART

Digital communications refer to digital transmission systems that use well known processing modules for processing the signal during transmission and reception as are illustrated by FIGS. 1 and 2.

The diagram in FIG. 1 illustrates a baseband architecture for a transmitter in a very generic manner. This architecture is able to process multiple users in an MU-MIMO mode just as well as one user or multiple users with an SU-MIMO mode. The input data pertaining to each user UE1, . . . , UEK come from a binary source such that these binary data are representative of, for example, an audio signal (voice), a multimedia signal (television streams, Internet streams), etc. The data of a user are conventionally encoded by an error correction encoder COD (for example convolutional code, turbo code, LDPC, polar code) known as a channel encoder. The data are conventionally block interleaved by an interleaver 7L. Possible demultiplexing provides for the data of a user to be distributed over multiple spatial layers. A MAP symbol binary encoder (referring to a mapper), also called a modulator, converts a block of binary data of a spatial layer, for example a codeword, after the possible demultiplexing, into a spatial stream of modulated symbols. A modulated symbol corresponds to a point in a constellation (BPSK, QPSK, mQAM, etc.). This modulator (mapper) matches m input data bits with a point in the 2^{m}-th order constellation (the constellation comprises 2^{m} points in the complex plane). It should be noted that the m in the expression mQAM (Quadrature Amplitude Modulation) denotes the modulation order. The spatial streams respectively associated with the spatial layers constitute the input streams of the MIMO (SU-MIMO or MU-MIMO) encoding. The choice of the type of MIMO encoding (spatial linear encoding, etc) is dependent on the knowledge of the transmission channel, which is known to the transmitter by way of, for example, an indicator (CQI, PMI, RI) fed back from the users. The data are transmitted between the spatial layers using the same time-frequency resource by antenna in accordance with an allocation of resources RES. There may therefore be interference between spatial layers.

An OFDM modulator MOD generates, from the symbols mapped to the subcarriers at the input, OFDM multicarrier symbols over time that are transmitted by an antenna ANT. This OFDM modulator MOD is realized by an inverse discrete Fourier transform (IDFT).

Among the various types of iterative receivers, iterative interference cancellation receivers have been known for more than 20 years, in particular from patent REF1. They are identified by the name soft IC, according to the terminology used for the 5G standard of the 3GPP. These receivers involve performing reference reception processing (reference receiver), which can be seen as an iteration zero with a detector (equalizer) and a decoder of the channel code (convolutional code, turbo code, LDPC), and then iterating multiple times between the decoding and the detection while cancelling, on each new iteration, the interference between spatial layers that is recreated following the decoding.

FIG. 2 shows a diagram illustrating the principle of an iterative interference cancellation receiver. The received signal Sᵣ is detected by a detector DET and then decoded by a decoder DECOD. A feedback loop sends back information about the decoding to the detector in order to perform interference cancellation IC. The possibly multi-user detector may be an MMSE soft IC (Minimum Mean-Square Error based soft Interference Cancellation) detector.

The principle of the MMSE Soft IC detector is as follows: the output of the decoder comprises soft information that is used to reconstruct the interfering symbols and thus to estimate the interference in order to cancel it; the interference cancellation is therefore performed in soft form. Various types of receivers are identified depending on whether the interference cancellation is performed successively, in parallel or using a hybrid method. When the cancellation is successive (SIC), each decoded user (UE) sees its signal cancelled and the successfully decoded users (UEs) are removed from the pool of users to be decoded before decoding the remaining users. When the cancelling is performed in parallel (PIC), the method performs detection and iterative decoding, all the users (UEs) are decoded in parallel and the successfully decoded users (UEs) see their signal removed from the pool of users (UEs) to be decoded for the next iteration. A hybrid receiver (soft-hard IC) uses a hard-IC detector to successively cancel the successfully decoded users on each iteration.

The diagram in FIG. 3 illustrates an architecture for a conventional baseband system of an iterative receiver equipped with two reception antennas. The receiver can also perform an iterative successive cancellation technique for the interference.

The receiver may also be equipped with two antennas. The number of reception antennas is independent of the number of transmission antennas. The iterative nature stems from the processing being iterated multiple times between the channel decoding performed by the decoder and the detection/equalization performed by the detector/equalizer for the same user.

On reception, a multicarrier demodulator DEMOD demodulates the multicarrier symbols received by an antenna in order to generate complex symbols. Given that the data intended for a user are transmitted using some of the time-frequency resources, the complex symbols mapped to these resources are extracted from the set of demodulated OFDM symbols in order to supply to the detector/equalizer. The RES⁻¹ extraction is performed knowing the resource allocation rules used for transmission. The MIMO⁻¹ detector/equalizer performs spatial multilayer detection (spatial streams or spatial layers) while making use of a priori information provided by the interfering symbol decoding performed by the decoder DECOD. This detector/equalizer may be a linear filter, the coefficients of which are corrected in the course of the iterations following interference cancellation. Dynamic correction of the coefficients of the linear filter is performed on the basis of statistical parameters of the signal estimated during the previous iteration and takes into account the estimation H of the transmission channel, the noise and the decoding from the previous iteration.

An MIMO⁻¹ detector/equalizer comprises a complex symbol demodulator and supplies to a soft decoder. The decoder receives non-binary values such as probability information at the input and also delivers non-binary outputs. Such a decoder having soft inputs and outputs is referred to as an SISO (soft input soft output) decoder. During each iteration i of the iterative receiver, the SISO decoder uses observations and probability quantities representative of a priori probabilities that it has on the encoded bits associated with the data provided by the demodulator following deinterleaving to evaluate probability quantities representative of a posteriori probabilities on these encoded bits. These a posteriori probabilities represent the transmission probabilities of these encoded bits and may take the form of logarithmic ratios of a posteriori probabilities LAPPR (Log A Posteriori Probability Ratio). The decoder DECOD therefore feeds back probability information about the encoded data to the detector/equalizer by way of a feedback loop. This information may be in the form of extrinsic information that, following interleaving, is considered to be a priori information by the MIMO⁻¹ detector/equalizer.

However, in an interference cancellation context, it may turn out that using a posteriori or LAPPR information instead of extrinsic or LEXTPR (Log EXTrinsec Probability Ratio) information gives better performance as described by REF2.

The channel estimation can be performed jointly by using weighted data provided by the decoder.

A new iteration is performed by using the updated channel estimation and cancellation of the contribution of the decoder in order to obtain extrinsic information.

The implementation of the iterative receivers remains complex and their realization necessitates a data decoding processing time that is greater the more the number of iterations performed by this type of receiver increases. This is all the more true for decoding downlink data carried by the physical channel PDSCH (Physical Downlink Shared CHannel) in LTE (4G) and in NR (5G) for a mobile terminal of smartphone type with limited computing power.

According to the specifications of the 5G standard of the 3GPP, one of the design criteria for this new generation is latency reduction compared with the specifications of the previous generation, i.e. LTE adv (4G 3GPP), for example for a service referred to as URLLC the latency needs to be less than 1 ms.

This latency reduction involves reducing the processing time for the data received by the mobile terminal. Accordingly, the network must imperatively know the minimum processing time required for decoding in order to be able to schedule the transmission of the HARQ-ACK/NACK, that is to say the uplink acknowledgement of the decoding of a transmitted data packet. This is because the acknowledgement cannot be provided until after the data of a packet have been decoded and an associated small error correction code (CRC) has been checked by the recipient.

The minimum processing time for the recipient to decode the data refers to two tables specified in the 3GPP Specification TS 38.214 V15.10.0 (2020 June) in subclause 5.3 entitled “UE PDSCH processing procedure time” in the table 5.3-1 Table 1 and in the table 5.3-2 Table 2, which are reproduced in the annex. The column μ gives the spacing between subcarriers of the transmitted OFDM signal, which is equal to 2^{μ}×15 kHz (see TS 38.300 V15.11.0 (2020 September) subclause 5.1), corresponding to an OFDM symbol duration of

$${T}_{s}^{μ} = \frac{1}{{2}^{μ} \times 15000} sec .$$

For a given μ, the minimum reception processing time of the PDSCH is therefore expressed as a number N₁ of OFDM symbols for a spacing between subcarriers 2^{μ}×15 kHz, corresponding to the processing time N₁Tₛ^{μ}.

To reduce delays in processing on reception, the specification TS 38.211 introduces reference signals (DMRS), situated at the start of the PDSCH (TS 38.214 Table 5.3-1 or Table 5.3-2 and =pos0), that allow an anticipated channel estimation before the reception of a data packet.

For better estimation of the transmission channel, additional reference signals can be introduced in the middle and/or at the end of the PDSCH, but taking these into account will affect the processing time for the channel estimation (Table 5.3-1 and ≠pos0).

When it initially accesses the network, the terminal UE transmits its minimum processing time to the base station while referring to one of the two tables given in the specification TS 38.214 and mentioned above as defined in 3GPP TS 38.306 V15.9.0 (2020 March) subclause 4.2.7.5 entitled “FeatureSetDownlink parameters”, Table 3, which is reproduced in the annex. The minimum processing time period is expressed as a number N of OFDM symbols between the last OFDM symbol of the PDSCH and the first OFDM symbol of the control channel carrying the acknowledgement of receipt ACK/NACK.

### SUMMARY

The invention relates to a telecommunication method with feedback from a terminal to an access point relating to a minimum processing time required for the terminal to perform N detection and decoding iteration(s) on at least one data packet transmitted by the access point and carried by the same physical channel. N≥1.

The invention also relates to a telecommunication terminal comprising:
an iterative receiver having N iteration(s) with soft detection and soft decoding of data packets transmitted by an access point,
a receiver for receiving a temporal indicator relating to a time allotted to the terminal by the access point for feeding back an acknowledgement of receipt after at least one data packet has been decoded by the iterative receiver,
a transmitter for:
   feeding back to the access point a minimum processing time required for the terminal to perform N detection and decoding iteration(s) on at least one data packet transmitted by the access point,
   transmitting an acknowledgement of receipt after at least one data packet has been decoded by the iterative receiver.

The invention also relates to an access point comprising:
a receiver for receiving a feedback from a terminal relating to a minimum processing time required for the terminal to perform N decoding iteration(s) on at least one data packet transmitted by the access point,
a transmitter for:
   transmitting data packets to at least one user,
   transmitting a temporal indicator relating to a time allotted to the terminal by the access point for feeding back an acknowledgement of receipt after at least one data packet has been decoded by the iterative receiver.

The invention also relates to a computer program on a storage medium, said program comprising program instructions suitable for performing a method according to the invention when said program is loaded and executed in a terminal or an access point.

The invention also relates to a storage medium comprising program instructions suitable for performing a method according to the invention when said program is loaded and executed in a terminal or an access point.

The invention also relates to a transmitted or received digital signal comprising a minimum processing time required for a terminal to perform N detection and decoding iteration(s) on a data packet transmitted by an access point and received by a terminal.

The iterative nature of the reception processing affords substantial improvements in the performance of a terminal, provided that the terminal has the time to perform its calculations. The invention defines an inexpensive protocol to ensure that the deployment of iterative receivers within an access network that is able to serve terminals of very different types, which do not allow the same performance levels to be achieved, effectively provides a gain.

Knowing the minimum processing time required by the terminal for carrying out one or more iterations and therefore achieving a certain data rate, knowing the constraints on the services demanded by the other terminals that are served and also their configuration and the radio quality information, the network is able to determine the best compromise between latency and data rate for the transmission to the terminal.

The gain is therefore both for the user of the terminal, who is able to benefit from a better data rate associated with better reception, and for the operator of the network, who is able to more effectively serve different terminals of different types, including of iterative type, by determining the best compromise between latency and data rate for a given service.

In an SU-MIMO context, the number of iterations is considered to be the number of decodings of the channel encoding performed by the decoder beyond the reference reception processing, which can be seen as an iteration zero. This number is proportional, in a first approximation, to the processing time required by the receiver for obtaining the decoded data.

In one embodiment of the invention, a detection and decoding iteration includes interference cancelling.

Thus, in this embodiment, the network allots a minimum time for the iterative reception receiver with interference cancellation to be able to perform complex processing.

The user is therefore confident of benefiting from higher performance levels. Moreover, this embodiment allows more users to be served by the same access point even though they may interfere with one another, since the invention guarantees a minimum processing time for the terminals to be able to perform their iterative reception with interference cancelling.

According to one embodiment of the invention, the processing time determined per iteration is the same for all iterations.

Thus, the total processing time is known immediately when the number of iterations is known, and vice versa.

According to one embodiment of the invention, a terminal capable of processing interference between users for an MU-MIMO transmission feeds back one additional processing time per iteration on the basis of a number of interfering users processed by the iterative decoding with interference cancellation, this additional time taking into account a structure of the multiuser receiver of SIC, PIC or hybrid type.

The access point knows the users in its radio coverage and is able to estimate among them those for which the interference cancellation must achieve a substantial gain for the terminal. Thus, when determining the compromise between latency and data rate, an access point is able to determine a number of interfering users that can be processed and for which the interference cancellation contributes to achieving the data rate.

According to one embodiment of the invention, a table of processing times is determined by terminal type and the minimum processing time is fed back by the terminal by indicating its SIC, PIC or hybrid type.

Such an embodiment allows the feedback of information associated with the processing time to be limited.

According to one embodiment of the invention, a table of processing times is determined by the terminal and the terminal feeds back the table to the access point.

Such an embodiment provides great flexibility.

According to one embodiment of the invention, for a data packet transmission comprising multicarrier symbols the processing time is quantified as a number of multicarrier symbols.

Such an embodiment is particularly suitable for transmission with multicarrier modulation, in particular of OFDM type.

According to one embodiment of the invention, the data packets are received by way of a PDSCH channel of a 5G access network.

According to one embodiment of the invention, the access point schedules a repetition mechanism for transmitted data packets by taking into account the minimum processing time required by the terminal for performing N′ decoding iteration(s). N′≥1.

According to one embodiment of the invention, the access point transmits to the terminal a temporal indicator relating to a time allotted to the terminal by the access point for feeding back an acknowledgement of receipt after at least one data packet has been decoded by the iterative receiver.

According to one embodiment of the invention, the terminal performs N″ detection and decoding iteration(s) for a received data packet, such that the processing time for the N″ iteration(s) is less than a time allotted to the terminal by the access point for feeding back an acknowledgement of receipt for the data packet. N″≥1.

### LIST OF FIGURES

Other features and advantages of the invention will become more clearly apparent on reading the description of embodiments that follows, said embodiments being provided by way of simple illustrative and nonlimiting examples, and the appended drawings, in which:

FIG. 1 is a diagram of a baseband architecture of a transmitter in a very generic manner, described with reference to the prior art,

FIG. 2 is a diagram illustrating the principle of an iterative interference cancellation receiver described with reference to the prior art,

FIG. 3 is a diagram of an architecture of a conventional baseband system of an iterative interference cancellation receiver equipped with two reception antennas, described with reference to the prior art,

FIG. 4 is a diagram of an embodiment of a terminal according to the invention,

FIG. 5 is a diagram of an embodiment of an access point according to the invention,

FIG. 6 is a diagram illustrating the principle of an iterative interference cancellation receiver of SIC type,

FIG. 7 is a diagram illustrating the principle of an iterative interference cancellation receiver of PIC type.

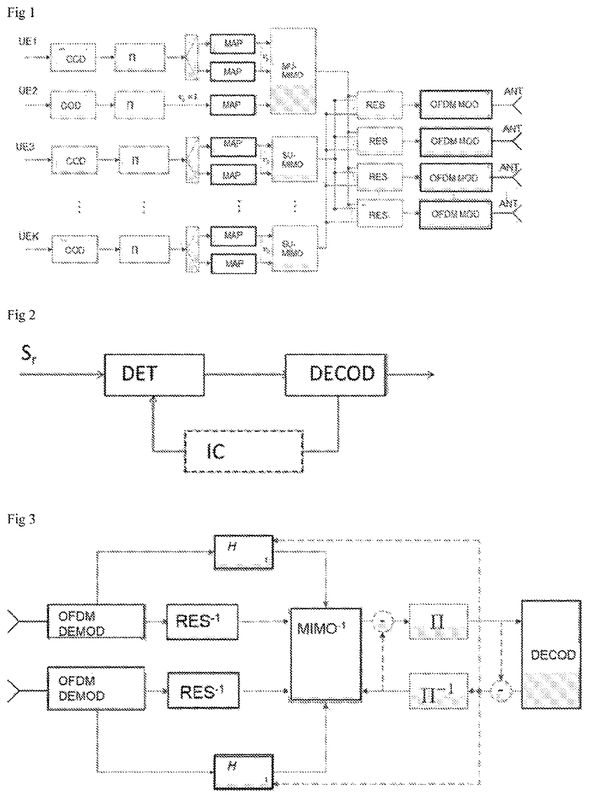

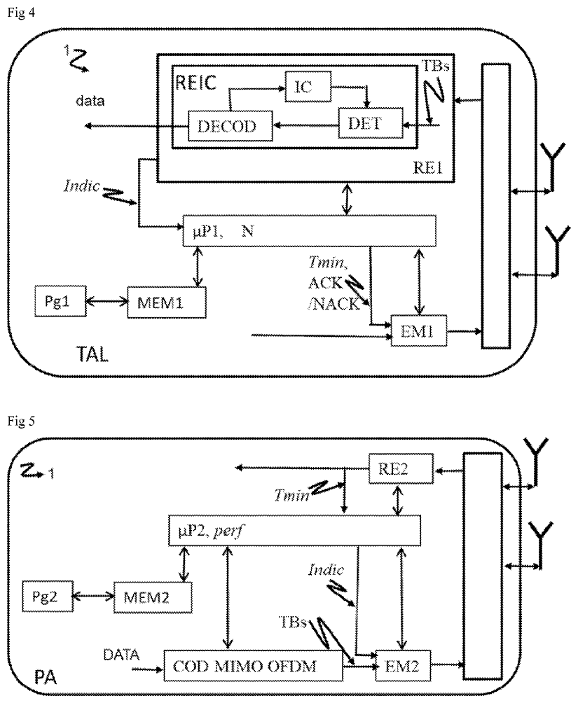

### DESCRIPTION OF PARTICULAR EMBODIMENTS

The invention concerns the context of communication with the transmission of data packets between two equipments. A terminal that wants to communicate with a more or less distant equipment generally uses an access network comprising an access point. The communication is set up by way of the access point. The access point denotes both a base station in a mobile access network and an access point in a fixed access network such as a WiFi network.

The simplified structure of an embodiment of a terminal according to the invention suitable for performing a method according to the invention is illustrated by FIG. 4.

The terminal TAL comprises a receiver RE1, a transmitter EM1, a memory MEM1 comprising a buffer, and a computer μP1, the operation of which is controlled by the execution of a program Pg1 whose instructions can be used to perform a telecommunication method 1 according to the invention.

On initialization, the code instructions of the program Pg are loaded into the buffer MEM1 before being executed by the processor P1, for example. The microprocessor μP1 controls the different components of the terminal, the receiver RE1 and the transmitter EM1.

The receiver RE1 comprises an iterative receiver REIC that performs one or more iterations of a soft detection DET and a soft decoding DECOD with interference cancellation IC on one or more data packets TBs transmitted by an access point by way of a transmission channel.

The receiver RE1 can moreover be used to receive a temporal indicator Indic transmitted by the access point, for example by way of a control channel. This temporal indicator Indic can be used to determine when and on what uplink channel (PUCCH/PUSCH) the terminal needs to feed back an acknowledgement of receipt ACK/NACK for the decoding, by its iterative receiver, of one or more data packets transmitted by the access point.

The transmitter EM1 can be used to:
feed back to the access point a minimum processing time Tmin required by the terminal for performing N iteration(s) of an iterative decoding with interference cancellation on one or more data packets transmitted by the access point,
transmit the acknowledgement of receipt ACK/NACK.

The temporal indicator Indic can be used to allot a time to the terminal during which it is able to perform no more than N′ decoding iteration(s) on one or more data packets and to feed back the acknowledgement of receipt. However, for a given packet, the receiver can perform only 1≤N″≤N′ iterations because it may be that the packet is decoded correctly before N′ iteration(s) are reached.

Thus, while executing the instructions, the microprocessor μP controls the transmitter EM1 so that it feeds back the minimum processing time Tmin. The microprocessor μP controls the receiver RE1 so that it receives the temporal indicator Indic. The microprocessor μP also controls the transmitter EM1 so that it transmits the acknowledgement of receipt ACK/NACK after the data packet has been decoded, while ensuring that the time between reception of the data packet and transmission of the acknowledgement of receipt ACK/NACK is less than or equal to the time allotted by the temporal indicator Indic.

FIG. 5 is a diagram of an embodiment of an access point according to the invention. The access point PA comprises a transmitter EM2, a receiver RE2, a memory MEM2 comprising a buffer, and a computer μP2, the operation of which is controlled by the execution of a program Pg2 whose instructions can be used to perform a telecommunication method 1 according to the invention.

The transmitter EM2 can be used to transmit data packets TBs to at least one user (terminal). The access point PA therefore also comprises a transmission system that generally comprises at least one channel encoding COD of input data, an MIMO encoding when the access point has multiple transmission antennas and a multicarrier OFDM modulation in order to generate these data packets.

The transmitter EM2 can also be used to transmit a temporal indicator Indic relating to the timing of the feedback of an acknowledgement of receipt ACK/NACK after one or more data packets have been decoded by the iterative receiver of the terminal.

The receiver RE2 can be used to receive a minimum processing time Tmin required by the terminal for performing N≥1 iterations of an iterative decoding with interference cancellation on one or more data packets transmitted by the access point.

Thus, while executing the instructions, the microprocessor μP controls the receiver RE1 so that it receives the processing time Tmin. The microprocessor μP controls the transmitter EM2 so that it transmits the indicator Indic temp.

Consequently, the invention also relates to a computer program or multiple computer programs, in particular a computer program on or in a storage medium, suitable for realizing the invention. This program can use any programming language and be in the form of source code, object code, or an intermediate code between source code and object code, such as in a partially compiled form, or in any other desirable form for implementing a method according to the invention.

The storage medium may be any entity or device capable of storing the program. For example, the medium may include a storage means, such as a ROM, for example a CD-ROM or a microelectronic circuit ROM, or else a magnetic recording means, for example a USB key or a hard disk.

Moreover, the storage medium may be a transmissible medium such as an electrical or optical signal, which may be conveyed by way of an electrical or optical cable, by radio or by other means. The program according to the invention may in particular be downloaded from an Internet network.

Alternatively, the storage medium may be an integrated circuit in which the program is incorporated, the circuit being designed to execute or to be used in the execution of the method in question.

Before the communication is set up, the terminal exchanges information with the access point generally by implementing a control protocol by way of a control channel. Among this information, the terminal is able to inform the access point of its capabilities: number of antennas, symbol binary modulations that it is able to decode, number of spatial layers that it is able to process, etc.

Using the telecommunication method 1 according to the invention, the terminal also feeds back to the access point a minimum processing time Tmin that it requires for performing N≥1 iterations of an iterative decoding with interference cancellation of one or more data packets transmitted by the access point.

According to one embodiment, the data packets are transmitted after a multicarrier, typically OFDM, modulation. The processing time can then be determined for a determined spacing value p between subcarriers. For example, for a terminal having a maximum number of iterations fixed at three, the left-hand part of Table 1, i.e. for DMRS signals in position 0, can thus become Table 4 reproduced in the annex with processing times determined for a number of iterations ranging from two to three.

A table of processing times can be determined by terminal type, i.e. SIC type, PIC type or hybrid type. Such a table is then known to the access point and the terminal, for example because it is specified in a standard. In this case, the feedback of the minimum processing time by the terminal is equivalent to a feedback of the indication of its type.

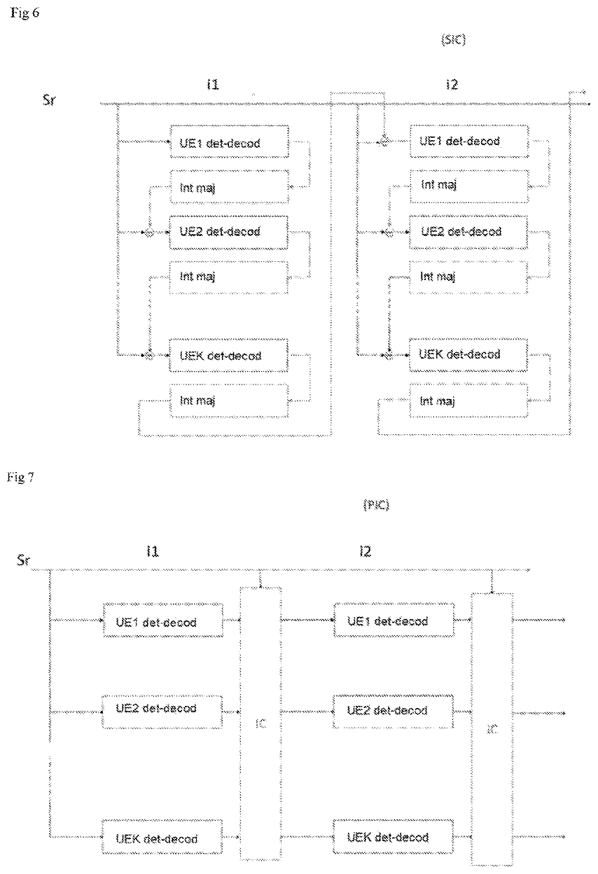

The principle of an iterative interference cancellation receiver of SIC type is illustrated by the diagram in FIG. 6. In each iteration i1, i2, the iterative receiver starts by detecting and decoding the first user UE1, UE1 det-decod on the basis of the input signal Sᵣ, generally the one received with the strongest signal, and then it successively detects and decodes the next users. It then determines the interference due to this first user UE1, Int maj, and subtracts it from the input signal in order to detect and decode the second user UE2, UE2 det-decod. It determines the interference due to the first and second users, Int maj, and subtracts it from the input signal in order to detect and decode the third user. This continues until the last user, the user UEK. It determines the interference due to the users UE2 to UEK and subtracts it from the input signal in order to detect and decode the first user UE1 during the next iteration i2. This next iteration then takes place in a similar manner to the previous iteration.

This next iteration can be followed by one or more other iterations that take place in a similar manner to the previous one.

The principle of an iterative interference cancellation receiver of PIC type is illustrated by the diagram in FIG. 7. In each iteration i1, i2, the iterative receiver detects and decodes UE1 det-decod, UE2 det-decod, UEK det-decod, all the users UE1-UEK in parallel. It then performs interference determination and interference cancellation IC for each of the users so that in the next iteration each detection and decoding of a user is performed on the basis of the input signal Sᵣ corrected for the interference due to the other users.

The number N of iterations is defined by the fact that the nth decoding of the same user as the receiver is trying to decode is part of the iteration n−1.

According to one embodiment, the terminal feeds back one additional processing time per iteration on the basis of a number K of interfering users processed by the iterative decoding with interference cancellation, this additional time taking into account a structure of the multiuser receiver of SIC, PIC or hybrid type.

In an MU-MIMO context, the reference reception processing, which can be seen as an iteration zero of a receiver of SIC type, may be either with mono-user decoding, the terminal attempting to decode only the data intended for it while considering the other users as interfering users without cancellation during this iteration zero in accordance with a first case, or with successive decoding of the other interfering users and interference cancellation after decoding of each user in accordance with a second case. In this second case, the reference processing time comprises an additional processing time compared with the reference processing time of the first case, corresponding to the decoding of K−1 interfering users. This processing time can be fed back to the access point by the terminal.

The minimum processing time for performing N iterations is, in all of these cases, the processing time beyond the reference time.

According to one embodiment, the table of processing times is determined by the terminal and the terminal feeds back the table to the access point, for example during information exchanges taking place before a communication is set up.

According to one embodiment, the processing time is quantified as a number of multicarrier symbols.

As already stated, the number of iterations is considered to correspond to the number of decodings of the channel encoding performed by the decoder (i.e. to the number of decoding iterations). Using this approximation, this number of iterations therefore reflects the processing time required by the receiver for obtaining the decoded data corresponding to one or more data packets using a time/frequency radio resource (shared physical channel, PDSCH), previously indicated to the terminal by a physical control channel (PDCCH Physical Downlink Control CHannel), defined by multiple OFDM symbols in time and multiple subcarriers in frequency.

According to one embodiment, the network (base station in a mobile access network or access point in a fixed access network such as a WiFi network) determines the best compromise between latency and data rate by taking into account the minimum processing time fed back by the terminal and information that is available (for example the type of service, the resources available in the uplink for transmitting the acknowledgement ACK/NACK, the TDD configuration in terms of slots for the uplink and the downlink, the radio conditions of the users in terms of interference and signal-to-noise ratio, etc.). This is because the greater the number of iterations that can be performed, the higher the attainable data rate but the greater the required latency. However, some services such as a service of URLLC type, of which a telemedicine application may be part, is associated with a very great latency constraint.

The result of this compromise is called the latency budget. It is transmitted to the terminal in the form of a temporal indicator Indic relating to a time allotted to the terminal by the access point for feeding back an acknowledgement of receipt after one or more data packets have been decoded by the iterative receiver. The latency budget corresponds to the time between reception of the PDSCH by the terminal and the time scheduled by the indicator indic for transmitting the acknowledgement of receipt ACK/NACK.

When the terminal has decoded one or more data packets and their check code (CRC), the terminal can feed back a message relating to correct reception ACK or incorrect reception NACK. The physical channel PDSCH transmits one or more data packets from the MAC layer, called “transport blocks” (TBs), per transmission (TTI Transmission Time Interval). It should be noted that the specification TS 38.212, paragraph 5.3.2, of the 5G standard defines only a single “transport block” (TB) per PDSCH for a transmission with up to four spatial layers to a terminal, whereas the specification TS 36.212, paragraph 5.3.2, of the LTE standard defines, in some cases, two “transport blocks” for which a single acknowledgement of receipt can be fed back by the terminal according to the specification TS 36.321, paragraph 5.3.2.1, of the LTE standard. According to the specification TS 38.321, paragraph 5.3.2.2, of the 5G standard, an acknowledgement of receipt can relate to one or two transport blocks.

The access point that receives an incorrect reception message NACK knows that the terminal has not been able to correctly decode the transmitted data packet(s). According to some implementations, a correct reception ACK or incorrect reception NACK message is associated with multiple data packets or “transport blocks” (TBs), or multiple ACK or NACK are transmitted simultaneously, one per packet.

A repetition mechanism can be implemented so that the access point retransmits the packet(s) affected by an incorrect reception message NACK.

According to this embodiment of the invention, the access point schedules the repetition mechanism for transmitted data packet(s) on the basis of the compromise called the latency budget. This compromise takes into account the minimum processing time Tmin required by the terminal for performing N decoding iterations and therefore for achieving a certain data rate, and takes into account imposed constraints and performance levels perf. Thus, the access point transmits to the terminal the time Indic during which the terminal must have fed back its correct reception ACK or incorrect reception NACK message. Knowing this time Indic that it has, the terminal adapts the number N″ of iterations that it performs before having to feed back its correct reception ACK or incorrect reception NACK message.

When the access point is a base station, the latter may be part of an access network of 5G type. The data packets are then transmitted by way of a PDSCH channel of the 5G access network.

### CITED REFERENCES

REF1: U.S. Pat. No. 6,763,076
REF2: B. Ning, R. Visoz and A. O. Berthet, “Extrinsic versus a Posteriori Probability based iterative LMMSE-IC algorithms for coded MIMO communications: Performance and analysis,” 2012 International Symposium on Wireless Communication Systems (ISWCS), Paris, 2012, pp. 386-390.

### Annex

TABLE 1
Table 5.3-1: PDSCH processing time
for PDSCH processing capability 1

| | PDSCH decoding time N₁ [symbols] | |
|---|---|---|
| | dmrs-AdditionalPosition = | dmrs-AdditionalPosition ≠ pos0 |
| | pos0 in DMRS- | in DMRS-DownlinkConfig in either |
| | DownlinkConfig | of dmrs-DownlinkForPDSCH- |
| | in both of dmrs- | MappingTypeA, |
| | DownlinkForPDSCH- | dmrs-DownlinkForPDSCH- |
| | MappingTypeA, dmrs- | MappingTypeB or |
| | DownlinkForPDSCH- | if the higher layer |
| μ | MappingTypeB | parameter is not configured |
| 0 | 8 | N_{1, 0} |
| 1 | 10 | 13 |
| 2 | 17 | 20 |
| 3 | 20 | 24 |

TABLE 2
Table 5.3-2: PDSCH processing time
for PDSCH processing capability 2

| | PDSCH decoding time N₁ [symbols] |
|---|---|
| | dmrs-AdditionalPosition = pos0 in |
| | DMRS-DownlinkConfig in both of |
| | dmrs-DownlinkForPDSCH-MappingTypeA, |
| μ | dmrs-DownlinkForPDSCH-MappingTypeB |
| 0 | 3 |
| 1 | 4.5 |
| 2 | 9 for frequency range 1 |

TABLE 3

| | | | | |
|---|---|---|---|---|
| pdsch-ProcessingType1-DifferentTB-PerSlot | FS | No | No | No |
| Defines whether the UE capable of processing time capability 1 | | | | |
| supports reception of up to two, four or seven unicast PDSCHs for | | | | |
| several transport blocks with PDSCH scrambled using C-RNTI, TC- | | | | |
| RNTI, or CS-RNTI in one serving cell within the same slot per CC that | | | | |
| are multiplexed in time domain only. | | | | |
| Note PDSCH(s) for Msg.4 is included. | | | | |
| pdsch-ProcessingType2 | FS | No | No | FR1 |
| Indicates whether the UE supports PDSCH processing capability 2. | | | | only |
| The UE supports it only if all serving cells are self-scheduled and if all | | | | |
| serving cells in one band on which the network configured | | | | |
| processingType2 use the same subcarrier spacing. This capability | | | | |
| signaling comprises the following parameters for each sub-carrier | | | | |
| spacing supported by the UE. | | | | |
| fallback indicates whether the UE supports PDSCH processing | | | | |
| capability 2 when the number of configured carriers is larger | | | | |
| than numberOfCarriers for a reported value of differentTB- | | | | |
| PerSlot. If fallback = ‘sc’, UE supports capability 2 processing | | | | |
| time on lowest cell index among the configured carriers in the | | | | |
| band where the value is reported, if fallback = ‘cap1-only’, UE | | | | |
| supports only capability 1, in the band where the value is | | | | |
| reported; | | | | |
| differentTB-PerSlot indicates whether the UE supports | | | | |
| processing type 2 for 1, 2, 4 and/or 7 unicast PDSCHs for | | | | |
| different transport blocks per slot per CC; and if so, it indicates | | | | |
| up to which number of CA serving cells the UE supports that | | | | |
| number of unicast PDSCHs for different TBs. The UE shall | | | | |
| include at least one of numberOfCarriers for 1, 2, 4 or 7 | | | | |
| transport blocks per slot in this field if pdsch-ProcessingType2 is | | | | |
| indicated. | | | | |
| pdsch-ProcessingType2-Limited | FS | No | No | FR1 |
| Indicates whether the UE supports PDSCH processing capability 2 with | | | | only |
| scheduling limitation for SCS 30 kHz. This capability signaling | | | | |
| comprises the following parameter. | | | | |
| differentTB-PerSlot-SCS-30 kHz indicates the number of different | | | | |
| TBs per slot. | | | | |
| The UE supports this limited processing capability 2 only if: | | | | |
| 1) One carrier is configured in the band, independent of the number | | | | |
| of carriers configured in the other bands; | | | | |
| 2) The maximum bandwidth of PDSCH is 136 PRBs; | | | | |
| 3) N1 based on Table 5.3-2 of TS 38.214 [12] for SCS 30 kHz. | | | | |

TABLE 4
dmrs-AdditionalPosition = pos0 in DMRS-DownlinkConfig
in both of dmrs-DownlinkForPDSCH-MappingTypeA,
dmrs-DownlinkForPDSCH-MappingTypeB

| | 0 iteration | 1 iteration | 2 iterations | 3 iterations |
|---|---|---|---|---|
| μ | N_{1, μ}⁽⁰⁾ | N_{1, μ}⁽¹⁾ | N_{1, μ}⁽²⁾ | N_{1, μ}⁽³⁾ |
| 0 | N_{1, 0}⁽⁰⁾ = 8 | N_{1, 0}⁽¹⁾ | N_{1, 0}⁽²⁾ | N_{1, 0}⁽³⁾ |
| 1 | N_{1, 1}⁽⁰⁾ = 10 | N_{1, 1}⁽¹⁾ | N_{1, 1}⁽²⁾ | N_{1, 1}⁽³⁾ |
| 2 | N_{1, 2}⁽⁰⁾ = 17 | N_{1, 2}⁽¹⁾ | N_{1, 2}⁽²⁾ | N_{1, 2}⁽³⁾ |
| 3 | N_{1, 3}⁽⁰⁾ = 20 | N_{1, 3}⁽¹⁾ | N_{1, 3}⁽²⁾ | N_{1, 3}⁽³⁾ |

Although the present disclosure has been described with reference to one or more examples, workers skilled in the art will recognize that changes may be made in form and detail without departing from the scope of the disclosure and/or the appended claims.

1. A telecommunication method comprising:
feeding back by a terminal to an access point a minimum processing time required for the terminal to perform N≥1 detection and decoding iteration(s) on at least one data packet transmitted by the access point and carried by a same physical channel.

2. The telecommunication method as claimed in claim 1, wherein a detection and decoding iteration of the N≥1 detection and decoding iteration(s) performed by the terminal includes interference cancellation.

3. The telecommunication method as claimed in claim 1, wherein the processing time determined per iteration is the same for all iterations.

4. The telecommunication method as claimed in claim 2, wherein the terminal is capable of processing interference between users for an MU-MIMO transmission and the method comprises the terminal feeding back one additional processing time per iteration on the basis of a number of interfering users processed by the iterative decoding with interference cancellation, this additional time taking into account a structure of a multiuser receiver of SIC, PIC or hybrid type.

5. The telecommunication method as claimed in claim 2, wherein the method comprises using a table of processing times by terminal type and the minimum processing time is fed back by the terminal by indicating its SIC, PIC or hybrid type.

6. The telecommunication method as claimed in claim 1, wherein the method comprises determining a table of processing times by the terminal and the terminal feeds back the table to the access point.

7. The telecommunication method as claimed in claim 1, wherein for a data packet transmission comprising multicarrier symbols the processing time is quantified as a number of multicarrier symbols.

8. The telecommunication method as claimed in claim 1, comprising the terminal receiving the data packets by way of a PDSCH channel of a 5G access network.

9. The telecommunication method as claimed in claim 17, wherein the method comprises the access point scheduling a repetition mechanism for transmitted data packets by taking into account the minimum processing time required by the terminal for performing N′≥1 iteration(s).

10. The telecommunication method as claimed in claim 9, wherein the method comprises the access point transmitting to the terminal a temporal indicator relating to a time allotted to the terminal by the access point for feeding back an acknowledgement of receipt after at least one data packet has been decoded by an iterative receiver of the terminal.

11. The telecommunication method as claimed in claim 1, wherein the method comprises the terminal performing N″≥1 detection and decoding iteration(s) on a received data packet, such that the processing time for the N″ iteration(s) is less than a time allotted to the terminal by the access point for feeding back an acknowledgement of receipt for the data packet.

12. A telecommunication terminal comprising:
an iterative receiver having N≥1 iteration(s) with soft detection and soft decoding of data packets transmitted by an access point;
a receiver configured to receive a temporal indicator relating to a time allotted to the terminal by the access point for feeding back an acknowledgement of receipt after at least one data packet has been decoded by the iterative receiver; and
a transmitter configured to:
feed back to the access point a minimum processing time required for the terminal to perform N≥1 detection and decoding iteration(s) on at least one data packet transmitted by the access point; and
transmit an acknowledgement of receipt after at least one data packet has been decoded by the iterative receiver.

13. An access point comprising:
a receiver configured to receive a feedback from a terminal relating to a minimum processing time required for the terminal to perform N≥1 decoding iteration(s) on at least one data packet transmitted by the access point; and
a transmitter configured to:
transmit data packets to the terminal; and
transmit a temporal indicator relating to a time allotted to the terminal by the access point for feeding back an acknowledgement of receipt after at least one data packet has been decoded by the iterative receiver.

14. (canceled)

15. (canceled)

16. (canceled)

17. A telecommunication method comprising:
receiving by an access point a feedback from a terminal relating to a minimum processing time required for the terminal to perform N≥1 detection and decoding iteration(s) on at least one data packet transmitted by the access point and carried by a same physical channel.
